(19) United States
(12) Patent Application Publication
(10) Pub. No.: US 2010/0193415 A1
(43) Pub. Date: Aug. 5, 2010

(54) FUEL FILTRATION DEVICE AND FUEL SUPPLY SYSTEM INCLUDING THE DEVICE

(75) Inventor: Koichi Nagai, Toyoake-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/693,750

(22) Filed: Jan. 26, 2010

(30) Foreign Application Priority Data
Feb. 4, 2009 (JP) 2009-23342

(51) Int. Cl. B01D 35/02; B01D 35/14; B01D 35/12

(52) U.S. Cl. 210/91; 210/132

(57) ABSTRACT

A fuel filtration device includes a first filter normally used to filter foreign substances in fuel, a second filter used to filter foreign substances in fuel only in a state where a degree of clogging of the first filter is larger than a predetermined level, and a regulating device for regulating a flow of fuel through the second filter. The regulating device disables the flow of fuel through the second filter to limit the filtering of foreign substances through the second filter when the degree of clogging of the first filter is equal to or smaller than the predetermined level. The regulating device enables the flow of fuel through the second filter to permit the filtering of foreign substances through the second filter when the degree of clogging of the first filter is larger than the predetermined level.

### CROSS REFERENCE TO RELATED APPLICATION

This application is based on and incorporates herein by reference Japanese Patent Application No. 2009-23342 filed on Feb. 4, 2009.

### BACKGROUND OF THE INVENTION

1. Field of the Invention

The present invention relates to a fuel filtration device having a filter for filtering off foreign substances in fuel, and to a fuel supply system including the device.

2. Description of Related Art

It is common for a vehicle to include a filter for filtering off foreign substances in fuel which is used for combustion of an internal combustion engine in the vehicle. As described in, for example, JP-UM-A-53-090126, when a differential pressure between before and after the filter exceeds a predetermined pressure, or when a travel distance of the vehicle exceeds a predetermined distance, for example, a driver is alarmed with a warning lamp or the like so as to prompt the driver to replace the filter.

However, when clogging of the filter becomes advanced, output of the engine sometimes decreases sharply due to shortage in supply of fuel to the engine. In this case, even though the alarm that prompts filter replacement is given, operation of the engine in an output reduced state is necessitated until the filter has been replaced, and in the worst case, the engine is stopped.

### SUMMARY OF THE INVENTION

The present invention addresses at least one of the above disadvantages. According to the present invention, there is provided a fuel filtration device including a first filter, a second filter, and a regulating means. The first filter is normally used to filter foreign substances contained in fuel. The second filter is used to filter the foreign substances contained in the fuel only in a state where a degree of clogging of the first filter is larger than a predetermined level. The regulating means is for regulating a flow of the fuel through the second filter. The regulating means disables the flow of the fuel through the second filter to limit the filtering of the foreign substances through the second filter when the degree of clogging of the first filter is equal to or smaller than the predetermined level. The regulating means enables the flow of the fuel through the second filter to permit the filtering of the foreign substances through the second filter when the degree of clogging of the first filter is larger than the predetermined level.

According to the present invention, there is also provided a fuel supply system for an internal combustion engine, including a fuel tank, a low pressure fuel pump, a high pressure fuel pump, and the fuel filtration device. The fuel tank receives fuel. The low pressure fuel pump pumps the fuel out of the fuel tank. The high pressure fuel pump further pressurizes and pumps the fuel, which is supplied from the low pressure fuel pump. The fuel filtration device is placed in one of a fuel conduit that connects between the fuel tank and the low pressure fuel pump, and a fuel conduit that connects between the low pressure fuel pump and the high pressure fuel pump.

### BRIEF DESCRIPTION OF THE DRAWINGS

The invention, together with additional objectives, features and advantages thereof, will be best understood from the following description, the appended claims and the accompanying drawings in which:

FIG. 1 is a diagram illustrating a fuel supply system in which a fuel filtration device in accordance with a first embodiment of the invention is disposed;

FIG. 2A is a diagram illustrating an operating state of the fuel filtration device in accordance with the first embodiment at normal time;

FIG. 2B is a diagram illustrating an operating state of the fuel filtration device in accordance with the first embodiment when clogging is caused;

FIG. 3 is a diagram illustrating structure of the fuel filtration device in accordance with the first embodiment;

FIG. 4 is a diagram illustrating a fuel supply system in which a fuel filtration device in accordance with a second embodiment of the invention is disposed;

FIG. 5A is a diagram illustrating an operating state of the fuel filtration device in accordance with the second embodiment at normal time; and

FIG. 5B is a diagram illustrating an operating state of the fuel filtration device in accordance with the second embodiment when clogging is caused.

### DETAILED DESCRIPTION OF THE INVENTION

Embodiments of the invention will be described below with reference to the accompanying drawings. The same numerals are used in the drawings to indicate the same or equivalent parts in the following embodiments, and the preceding description of the component having the same numeral is referred to when explaining the parts with the same numerals.

### First Embodiment

A fuel filtration device according to a first embodiment of the invention is provided for instance, for a common rail type fuel supply system for a diesel engine (internal combustion engine) for an automobile.

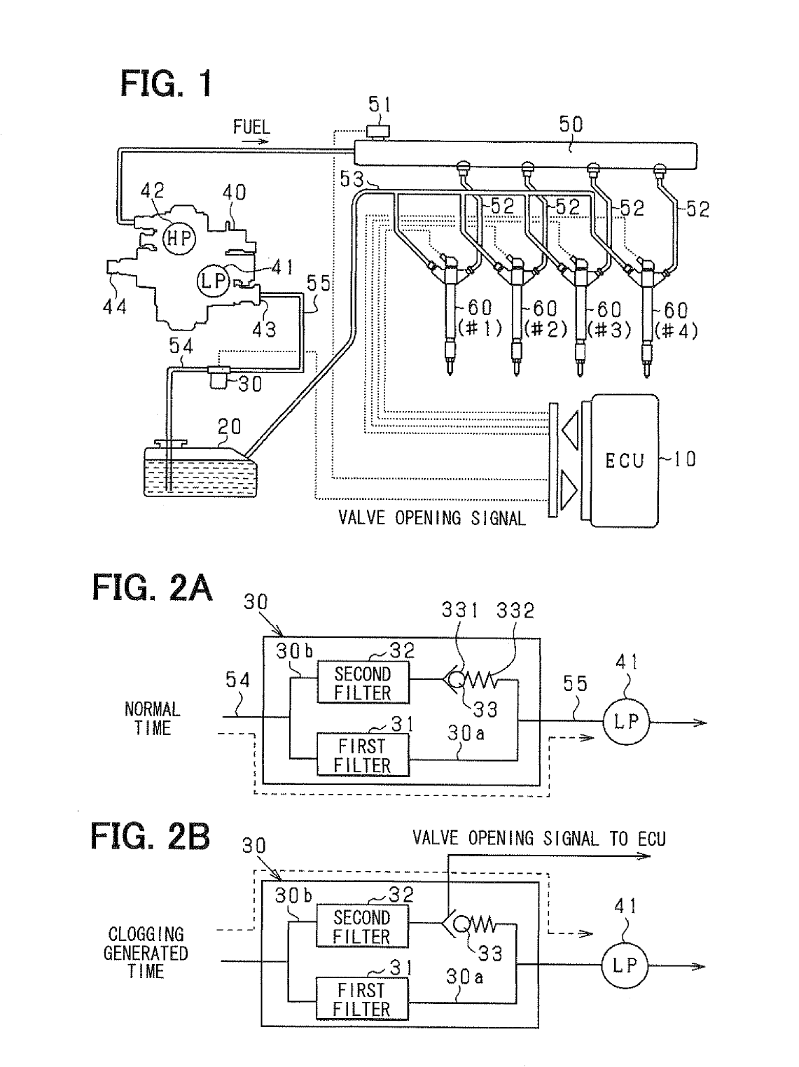

With reference to FIG. 1, the common rail type fuel supply system of the first embodiment will be roughly described below. Generally, this system is configured such that an electronic control unit (ECU) 10 receives sensor outputs from various sensors, and controls devices that constitute the fuel supply system based on the sensor outputs. The ECU 10 feedback-controls fuel pressure in a common rail 50 (current fuel pressure measured by a rail pressure sensor 51) to be a target value (target fuel pressure) by adjusting an amount of current supplied to a suction regulating valve (to be described in greater detail hereinafter) so as to control a fuel discharged amount from a pumping device 40 to be a desired value. Based on the above fuel pressure, the ECU 10 controls fuel injection quantity toward a predetermined cylinder of a target engine and eventually an output of the engine (rotational speed or torque of an output shaft), to be a desired value.

The fuel supply system includes a fuel tank 20, a fuel filtration device 30, the pumping device 40, the common rail 50, and injectors 60 (fuel injection valves), which are arranged in this order in a flow direction of the fuel (i.e., from the upstream side to the downstream side). In this system, fuel in the fuel tank 20 is pressure-fed through the pumping device 40, so that fuel is supplied to a target device in the system.

Next, the structure of the pumping device 40 will be explained below.

The pumping device 40 includes a feed pump 41 (fuel pump) and a high pressure pump 42, which will be described below, and is configured such that fuel pumped up from the fuel tank 20 by the feed pump 41 is pressurized through the high pressure pump 42 to be discharged. Meanwhile, the amount of fuel fed to the high pressure pump 42 is regulated by a suction regulating valve (not shown) disposed on a fuel-suction side of the high pressure pump 42.

The feed pump 41 functions as a “low pressure supply pump”. The feed pump 41 suctions the fuel in the fuel tank 20 through a inlet 43 to be fed into the high pressure pump 42, and a trochoid pump may be used for the feed pump 41. The suction regulating valve is controlled by the ECU 10 to regulate an amount of fuel suctioned from the feed pump 41 into the high pressure pump 42. More specifically, the amount of the fuel fed by the feed pump 41 is regulated to be a required discharge amount through this suction regulating valve, and then the fuel flows into the high pressure pump 42. Accordingly, a discharge amount of fuel that is pressure-fed from the pumping device 40 to the common rail 50 is controlled.

The high pressure pump 42 is a plunger pump for pressurizing fuel, whose amount is regulated through the suction regulating valve, and for discharging the fuel into the outside. The feed pump 41 and the high pressure pump 42 are driven by rotation of a drive shaft 44, and the drive shaft 44 is driven in accordance with rotation of a crankshaft (output shaft of the engine). Therefore, the feed pump 41 and the high pressure pump 42 are driven by power from the engine output. As described above, when the pumping device 40 is activated, the fuel in the fuel tank 20 is pumped up through the operation of the feed pump 41, and then pressurized and supplied (pressure-fed) into the common rail 50 through the operation of the high pressure pump 42 after the regulation of its flow rate through the suction regulating valve.

The common rail 50 stores the fuel, which has been pressure-fed from the above-described pumping device 40, in a high pressure state, and supplies the fuel to the injector 60 of each cylinder through a high pressure pipe 52 provided for each of cylinders #1 to #4. The injector 60 is provided for each combustion chamber in the cylinders #1 to #4, and injects high pressure fuel which is pressure-accumulated and held in the above common rail 50. An excess amount of fuel supplied to the injector 60 is returned into the fuel tank 20 through a low pressure pipe 53.

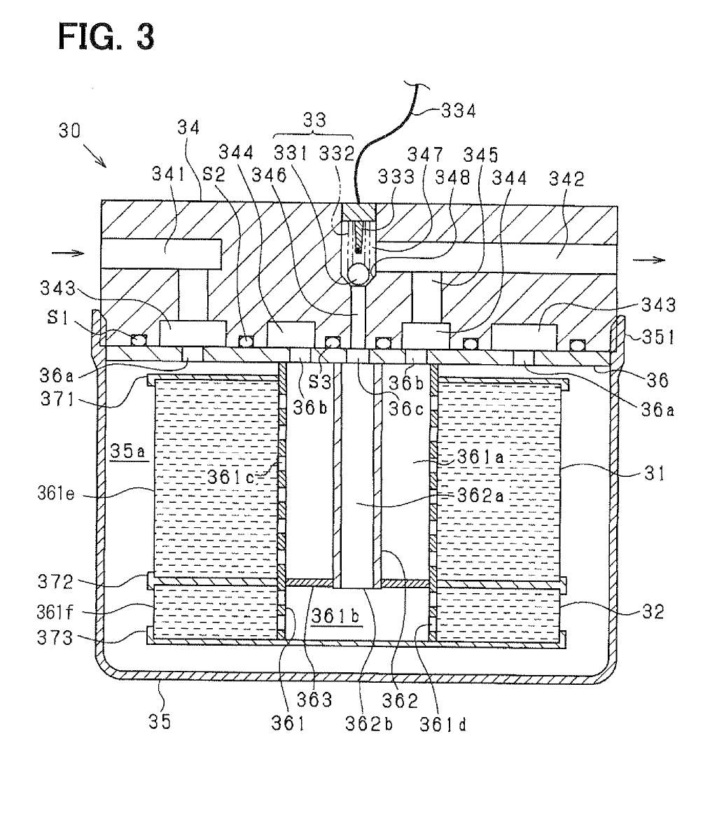

Constitution of the fuel filtration device 30, which is a main feature of the present embodiment, will be described below with reference to FIGS. 2A to 3. FIGS. 2A and 2B illustrate a route through which fuel flows in the fuel filtration device 30, and FIG. 3 is a sectional view illustrating structure of the fuel filtration device 30.

As shown in FIGS. 1 to 2B, the fuel filtration device 30 is disposed on a upstream side of the feed pump 41 in the fuel flow direction, and fuel flows through the inside of the fuel filtration device 30 by suction negative pressure of the feed pump 41. The fuel filtration device 30 includes two filters (a first filter 31 and a second filter 32) as filters for filtering off foreign substances in fuel. A first flow route 30a in which the first filter 31 is disposed and a second flow route 30b in which the second filter 32 is disposed, are arranged in a communication passage formed inside the fuel filtration device 30. Both these flow routes 30a, 30b communicate with each other in parallel arrangement.

A valve 33 (regulating means) that opens and closes the second flow route 30b is disposed in a portion of the second flow route 30b on a downstream side of the second filter 32. The valve 33 is a mechanical valve including a valve plug 331 for opening and closing the second flow route 30b and a spring 332 for urging the valve plug 331 in a valve closing direction. The valve plug 331 opens the second flow route 30b when a differential pressure between before and after the valve 33 exceeds a set pressure.

Urging force of the spring 332 is set such that the valve plug 331 of the valve 33 closes the second flow route 30b at normal time when the first filter 31 is not clogged (see FIG. 2A). In other words, the above-described set pressure for the valve 33 is higher than the differential pressure between before and after the valve 33 at normal time.

When the clogging of the first filter 31 becomes advanced, a differential pressure between before and after the first filter 31 becomes large. Accordingly, suction negative pressure of the feed pump 41 becomes high, so that pressure on a downstream side of the first filter 31 in the fuel flow direction decreases. When the pressure on a downstream side of the first filter 31 is reduced in the above manner, pressure on a downstream side of the valve 33 in the fuel flow direction decreases simultaneously. Therefore, the differential pressure between before and after the valve 33 becomes large, and as illustrated with FIG. 2B, the valve plug 331 of the valve 33 is operated to open the second flow route 30b against the urging force of the spring 332. In other words, the urging force of the spring 332 is set such that the valve plug 331 opens the second flow route 30b at the time that the first filter 31 is so clogged that the first filter 31 needs to be replaced (hereinafter referred to simply as “clogging generated time”). Thus, the above-described set pressure for the valve 33 is set to coincide with the differential pressure between before and after the valve 33 at the clogging generated time of the first filter 31, and is thereby set based on the above-described negative pressure at the clogging generated time.

Accordingly, at normal time, fuel flows into the first filter 31, while a flow into the second filter 32 is blocked by the valve 33. Hence, fuel flows along the first flow route 30a as illustrated with a dashed line in FIG. 2A, and the second filter 32 is bypassed. On the other hand, at the clogging generated time, fuel flows into the second filter 32 as indicated by a dashed line in FIG. 2B in accordance with the opening operation of the valve 33.

A specific structure of the fuel filtration device 30 will be explained below.

As shown in FIG. 3, the fuel filtration device 30 includes the first and second filters 31, 32, a metal filter head 34, and a filter holding member. A fuel inlet passage 341 (fuel inlet) and a fuel outlet passage 342 (fuel outlet) are formed in the filter head 34. The filter holding member, which is described in greater detail hereinafter, holds the first and second filters 31, 32, and is attacked to the filter head 34. In the following description, a filter holding member-side (lower side of FIG. 3) of the filter head 34 is referred to as a “lower side”, and an opposite side of the filter head 34 from the filter holding member (upper side of FIG. 3) is referred to as an “upper side.”

The filter head 34 has a cylindrical shape, and the fuel inlet passage 341 and the fuel outlet passage 342 open on an outer circumferential surface of the filter head 34. An entrance pipe 54 (see FIGS. 1 to 2B) that communicates with the fuel tank 20 is connected to the fuel inlet passage 341, and an outlet pipe 55 (see FIGS. 1 to 2B) that communicates with the pumping device 40 is connected to the fuel outlet passage 342.

An annular inlet groove 343 that communicates with the fuel inlet passage 341, and an annular outlet groove 344 that communicates with the fuel outlet passage 342 are formed on a lower end surface of the filter head 34. The fuel outlet passage 342 branches into a first flow passage 345 and a second flow passage 346, and the outlet groove 344 communicates with the fuel outlet passage 342 via the first flow passage 345. The first flow passage 345 and the outlet groove 344 serve as a part of the first flow route 30a which is described above using FIGS. 2A and 2B, and the second flow passage 346 serves as a part of the second flow route 30b which is illustrated with FIGS. 2A and 2B.

A valve accommodating chamber 347 that accommodates the valve plug 331 of the valve 33 and the spring 332 is formed in the second flow passage 346. The second flow passage 346 is closed as a result of engagement of the valve plug 331 with a seat surface 348 of the valve accommodating chamber 347, and the second flow passage 346 is opened as a result of disengagement of the valve plug 331 from the seat surface 348.

The valve accommodating chamber 347 further includes a switch 333 (sensing means) for outputting a valve opening signal when the valve 33 opens the second flow passage 346. A contact-type switch which is pressed and moved by the valve plug 331 disengaging from the seat surface 348 is used for the switch 333. An ON signal (valve opening signal) of the switch 333 is transmitted to the ECU 10 through a communication line 334. Upon receiving the valve opening signal, the ECU 10 provides a notification to a driver of a vehicle to prompt replacement of the first filter 31. The above alarm is given for instance, by indicating a warning on a display of an instrument panel on which various instruments such as a vehicle speed meter are arranged.

The filter holding member includes a case 35, a lid member 36, an outer pipe 361, an inner pipe 362, a partition plate 363, an upper stay 371, an intermediate stay 372, and a lower stay 373, which are described in greater detail hereinafter. All the members 35, 36, 361 to 363, and 371 to 373 that constitute the filter holding member are made of metal, and the members are joined to each other by welding, for instance.

The case 35 is formed in a cylindrical shape having a bottom part whose upper portion opens, and an opening of the case 35 is closed by the lid member 36. An accommodating space 35a that accommodates the first and second filters 31, 32 is defined inside the case 35 and the lid member 36.

The lid member 36 has a disc shape whose peripheral edge is welded to the case 35, and an inlet port 36a, a first outlet hole 36b, and a second outlet hole 36c, which will be described below, are formed on the lid member 36. The inlet port 36a is a through hole that communicates between the inlet groove 343 and the accommodating space 35a, and formed annularly along the inlet groove 343. The first outlet hole 36b is a through hole that communicates between the outlet groove 344 and the accommodating space 35a, and formed annularly along the outlet groove 344. The second outlet hole 36c is a through hole that communicates between the second flow passage 346 and the accommodating space 35a. The first outlet hole 36b and the outlet groove 344 are located respectively annularly inward of the inlet port 36a and the inlet groove 343, and the second outlet hole 36c and the second flow passage 346 are located respectively annularly inward of the first outlet hole 36b and the outlet groove 344.

The outer pipe 361 and the inner pipe 362 are formed in a cylindrical shape extending in upper and lower directions, and the inner pipe 362 is arranged inside the outer pipe 361. An upper end portion of the inner pipe 362 is welded onto a lower surface of the lid member 36 such that a cylinder interior portion 362a communicates with the second outlet hole 36c. An upper end portion of the outer pipe 361 is welded onto a lower surface of the lid member 36 such that a cylinder interior portion 361a communicates with the first outlet hole 36b. Accordingly, the cylinder interior portion 362a of the inner pipe 362 functions as a part of the second flow route 30b which is illustrated with FIGS. 2A and 2B, and the cylinder interior portion 361a of the outer pipe 361 functions as a part of the first flow route 30a which is illustrated with FIGS. 2A and 2B.

The partition plate 363 is formed in a disc shape that divides the cylinder interior portion of the outer pipe 361 in the upper and lower directions. A part (portion indicated by the numeral 361a) of the cylinder interior portion of the outer pipe 361 above the partition plate 363 communicates with the first outlet hole 36b to constitute the first flow route 30a as describe above, and a part (portion indicated by the numeral 361b) of the cylinder interior portion of the outer pipe 361 below the partition plate 363 communicates with the cylinder interior portion 362a of the inner pipe 362 to serve as a part of the second flow route 30b.

The upper stay 371 and the intermediate stay 372 are formed in a disc shape extending radially outward from an outer circumferential surface of the outer pipe 361, and the lower stay 373 has a disc shape that is welded to an open end of the outer pipe 361 so as to close the cylinder interior portion 361b of the outer pipe 361. The first filter 31 is fitted and held between the upper stay 371 and the intermediate stay 372, and the second filter 32 is fitted and held between the intermediate stay 372 and the lower stay 373.

First communicating holes 361c that constitute the first flow route 30a are formed on a portion of the outer pipe 361 opposed to the first filter 31, and second communicating holes 361d that constitute the second flow route 30b are formed on a portion of the outer pipe 361 opposed to the second filter 32. In addition, an outer peripheral surface of the first filter 31 is referred to as an inlet 361e, and an outer peripheral surface of the second filter 32 is referred to as an inlet 361f.

By virtue of the above-described constitution, fuel, which has flowed into the fuel filtration device 30 from the entrance pipe 54, flows into the accommodating space 35a through the fuel inlet passage 341, the inlet groove 343, and the inlet port 36a. Then, after a flow of the fuel through the first flow route 30a or the second flow route 30b, which is described in greater detail hereinafter, the fuel flows out of the device 30 to the outlet pipe 55 through the fuel outlet passage 342.

The first flow route 30a which leads fuel into the first filter 31 includes the first communicating hole 361c, the cylinder interior portion 361a of the outer pipe 361, the first outlet hole 36b, the outlet groove 344, and the first flow passage 345 in this order from the upstream side in the fuel flow direction. The second flow route 30b through which fuel flows into the second filter 32 includes the second communicating holes 361d, the cylinder interior portion 361b of the outer pipe 361, the opening 362b and the cylinder interior portion 362a of the inner pipe 362, the second outlet hole 36c, and the valve accommodating chamber 347 in this order from the upstream side in the fuel flow direction.

The first filter 31 and the second filter 32 are filter elements which are composed, for instance, by pasting two or more sheets of filter material together, and the first and second filters 31, 32 are the elements formed separately from each other. A filtration area of the second filter 32 is made smaller than a filtration area of the first filter 31. The filter element has a function of capturing foreign substances included in fuel (light oil), a function of removing moisture in fuel, and a function of removing a wax component in fuel. As time of use passes, the captured foreign substances and wax component, for example, deposit in the filter element so as to clog these first and second filters 31, 32. The filter element that is clogged above a certain level has reached the end of the lifetime, so that it needs replacement.

When the first filter 31 is replaced, the filter holding member is detached from the filter head 34. By screwing and joining the upper end portion 351 of the case 35 to the filter head 34, the filter holding member is detachably attached to the filter head 34. In a screwed state (state illustrated with FIG. 3), a lower surface of the filter head 34 and an upper surface of the lid member 36 are in a closely-attached state therebetween. In particular, clearance between the inlet groove 343 and the inlet port 36a, clearance between the outlet groove 344 and the first outlet hole 36b, and clearance between the second flow passage 346 and the second outlet hole 36c, are sealed with a sealing member (e.g., O ring) to prevent leakage of fuel.

When the clogged first filter 31 is replaced with a new first filter 31, the upper end portion 351 of the case 35 is detached from the filter head 34, and a new filter holding member holding new first and second filters 31, 32 is attached to the filter head 34. Therefore, when the first filter 31 is replaced by a new filter, the first filter 31 is changed together with the filter holding member and the second filter 32.

Operation of the fuel filtration device 30 illustrated in FIG. 3 will be described below.

At normal time when the first filter 31 is not clogged, the second flow passage 346 leading to the second filter 32 is closed because the valve 33 closes the second flow route 30b (state illustrated in FIGS. 3 and 2A). Accordingly, fuel, which has flowed into the accommodating space 35a from the fuel inlet passage 341 through the inlet groove 343 and the inlet port 36a, does not flow in the second flow route 30b, but flows along the first flow route 30a. Therefore, the fuel flows through the first filter 31, and a flow of fuel through the second filter 32 is closed.

Then, when the clogging of the first filter 31 becomes advanced, the suction negative pressure of the feed pump 41 becomes high, so that the pressure on the downstream side of the first filter 31 (pressure in the fuel outlet passage 342) decreases. As a result, the pressure on the downstream side of the valve 33 (pressure in the valve accommodating chamber 347) is reduced, and thereby the valve 33 opens the second flow route 30b (state illustrated in FIG. 2B). For this reason, fuel, which has flowed in through the fuel inlet passage 341, does not flow toward the first flow route 30a having a high pressure loss due to the clogging of the first filter 31. Instead, the fuel flows through the second filter 32 which is not clogged and thus has a lower pressure loss than the first filter 31.

According to the present embodiment explained in full detail above, the following advantageous effects are produced.
(1) The fuel filtration device 30 includes the second filter 32 in addition to the first filter 31 that is used at normal time. At normal time, fuel flows through the first filter 31, whereas the flow into the second filter 32 is blocked by the valve 33. When the first filter 31 is clogged, fuel flows through the second filter 32 in accordance with the opening operation of the valve 33. Therefore, the first filter 31 fulfills a filtering function, and the second filter 32 is not made to capture foreign substances in fuel at normal time, and the second filter 32, which is not used at normal time, is made to fulfill a filtering function when the first filter 31 is clogged. Accordingly, if the first filter 31 is clogged, the engine is operated with the second filter 32 in use until the first filter 31 has been replaced. Thus, shortage in supply of fuel to the engine is relieved, so that a state of reduction in output of the engine is avoided.
(2) The present embodiment is aimed at the fuel filtration device 30 disposed on the upstream side of the feed pump 41, and fuel flows through the inside of the fuel filtration device 30 due to the suction negative pressure of the feed pump 41. In such a suction negative pressure-type fuel filtration device 30, the passage downstream of the first filter 31 is connected with the downstream side of the valve 33. The valve 33 is set to open the second flow route 30b, when the pressure on the downstream side of the first filter 31 decreases in accordance with the generation of clogging of the first filter 31 so that the pressure on the downstream side of the valve 33 falls below a predetermined pressure. Accordingly, the fuel filtration device 30 switches between the first and second flow routes 30a, 30b at normal time or at the clogging generated time by employing a mechanical valve without using a magnet-type valve for the valve 33. As a result, electronic control means such as an electronic circuit needed when the switching is electronically controlled using the magnet-type valve becomes unnecessary, and cost reduction in the fuel filtration device 30 is achieved using a cheap mechanical valve.
(3) Although the second filter 32 is not for normal use, when the second filter 32 is used repeatedly because of the clogging of the first filter 31, the second filter 32 is also clogged, so that the filter 32 requires replacement, too. Accordingly, if the second filter 32 is used continuously without replacement, a state of reduction in output of the engine until the first filter 31 has been replaced, cannot be avoided. In the present embodiment, in view of this, both the first and second filters 31, 32 are held by a single filter holding member, and the filter holding member is attached to and removed from the filter head 34 with both the filters 31, 32 being held. Therefore, when the first filter 31 is replaced by a new filter, the first filter 31 is changed together with the filter holding member and the second filter 32. Or, after the filter holding member is removed from the filter head 34, both the filters 31, 32 that are held by the filter holding member are replaced. Hence, forgetting to replace the second filter 32 is limited compared to a case where both the filters 31, 32 are separately detached from the filter head 34 to be replaced. Furthermore, according to the present embodiment, replacement of the second filter 32 is carried out simultaneously with replacement of the first filter 31. As a result, workability in replacement of both the filters 31, 32 improves.
(4) In the present embodiment, when the valve 33 opens the second flow route 30b in accordance with the generation of clogging of the first filter 31, the valve opening signal is outputted to the ECU 10 from the switch 333. Consequently, the ECU 10 recognizes time for replacement of the first filter 31 based on whether this valve opening signal has been sent. More specifically, the time for replacement (clogging generated time) of the first filter 31 is recognized using the valve 33 for switching between the first and second flow routes 30a, 30b. In consequence, a dedicated detecting means for detecting a clogging state of the first filter 31 (e.g., differential pressure sensor for detecting the differential pressure between before and after the first filter 31) is made unnecessary.
(5) In the present embodiment, the filtration area of the second filter 32 is smaller than the filtration area of the first filter 31. More specifically, sizes of both the filters 31, 32, which have a cylindrical shape, in their radial direction are made the same, and a size of the second filter 32 in a direction of its cylindrical shaft (upper and lower directions) is made smaller than the first filter 31. Because the second filter 32 is less frequently used compared to the first filter 31, by making smaller the second filter 32 than the first filter 31 in the above-described manner, the filtering function of the first filter 31 at normal time and the filtering function of the second filter 32 at the clogging generated time are fully carried out, and an installation space for the fuel filtration device 30 in the upper and lower directions is made small.

### Second Embodiment

In the above first embodiment illustrated in FIG. 1, the pumping device 40 is configured such that the feed pump 41 and the high pressure pump 42 are accommodated in the same case, and the fuel filtration device 30 is disposed on the upstream side of the feed pump 41 in a fuel flow direction. Therefore, the fuel filtration device 30 of the first embodiment is a suction negative pressure-type filtration device in which fuel flows through the first and second flow routes 30a, 30b due to the suction negative pressure of the feed pump 41.

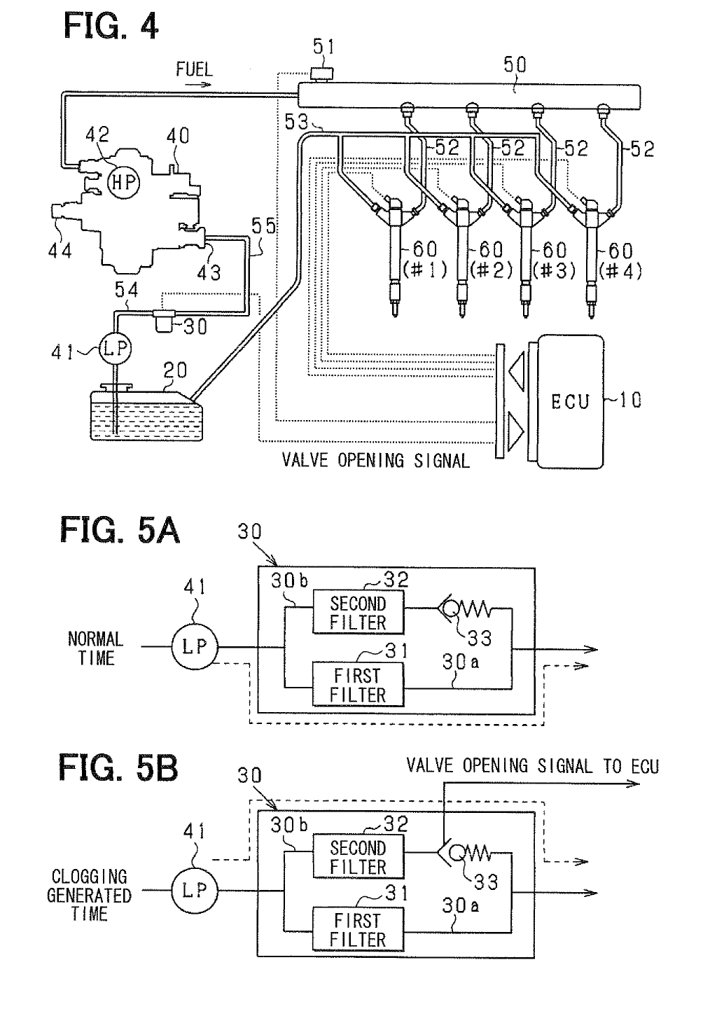

On the other hand, a pumping device 40 according to the present embodiment illustrated with FIG. 4 is configured such that a feed pump 41 and a high pressure pump 42 are separately arranged, and a fuel filtration device 30 is disposed on a downstream side of the feed pump 41 in the fuel flow direction. Therefore, the fuel filtration device 30 of the present embodiment is a discharge pressure (positive pressure)-type filtration device in which fuel flows through the first and second flow routes 30a, 30b by discharge pressure from the feed pump 41. In addition, structure of the fuel filtration device 30 of the second embodiment is the same as the above first embodiment illustrated in FIG. 3, and only a set pressure for a valve 33, which is described in greater detail hereinafter, is different from the first embodiment.

More specifically, similar to the first embodiment, the fuel filtration device 30 of the present embodiment includes two filters (i.e., a first filter 31 and a second filter 32) as illustrated with FIGS. 5A and 5B. A first flow route 30a in which the first filter 31 is disposed and a second flow route 30b in which the second filter 32 is disposed, are arranged along a flow route formed inside the fuel filtration device 30, and both these flow routes 30a, 30b communicate with each other in parallel arrangement. The valve 33 that opens and closes the second flow route 30b is disposed in a portion of the second flow route 30b on a downstream side of the second filter 32 in the fuel flow direction, and this valve 33 opens the second flow route 30b when a differential pressure between before and after the valve 33 exceeds a set pressure.

Urging force of a spring 332 is set such that a valve plug 331 of the valve 33 closes the second flow route 30b at normal time when the first filter 31 is not clogged (see FIG. 5A). In other words, the above-described set pressure for the valve 33 is higher than the differential pressure between before and after the valve 33 at normal time.

As the clogging of the first filter 31 becomes advanced, pressure on an upstream side of the first filter 31 in the fuel flow direction, i.e., pressure (positive pressure) on a discharge side of the feed pump 41 becomes higher. When the positive pressure of the feed pump 41 becomes high in the above-described manner, pressure on upstream and downstream sides of the second filter 32 increases, so that pressure on an upstream side of the valve 33 also increases simultaneously. Accordingly, the differential pressure between before and after the valve 33 becomes large, and as shown in FIG. 5B, the valve plug 331 of the valve 33 is operated to open the second flow route 30b against the urging force of the spring 332. In other words, the urging force of the spring 332 is set such that the valve plug 331 opens the second flow route 30b at the clogging generated time of the first filter 31. Thus, the above-described set pressure for the valve 33 is set to coincide with the differential pressure between before and after the valve 33 at the clogging generated time of the first filter 31, and is thereby set based on the above-described positive pressure at the clogging generated time.

According to the present embodiment explained in full detail above, the above-described advantageous effects (1) and (3) to (5) are produced, and the following advantageous effects are produced similar to the above effect (2).
(6) The present embodiment is aimed at the fuel filtration device 30 disposed on the downstream side of the feed pump 41, and fuel flows through the inside of the fuel filtration device 30 due to the discharge pressure of the feed pump 41. In such a discharge positive pressure-type fuel filtration device 30, the passage downstream of the second filter 32 is connected with the upstream side of the valve 33. The valve 33 is set to open the second flow route 30b, when the pressure on the downstream side of the second filter 32 increases in accordance with the generation of clogging of the first filter 31 so that the pressure on the upstream side of the valve 33 exceeds a predetermined pressure. Accordingly, the fuel filtration device 30 switches between the first and second flow routes 30a, 30b at normal time or at the clogging generated time by employing a mechanical valve without using a magnet-type valve for the valve 33. As a result, electronic control means such as an electronic circuit needed when the switching is electronically controlled using the magnet-type valve becomes unnecessary, and cost reduction in the fuel filtration device 30 is achieved using a cheap mechanical valve.

Moreover, according to the above-described fuel filtration device 30 of the first and second embodiments, only by changing the set pressure for the valve 33 between in the case of the fuel filtration device 30 disposed on the upstream side of the feed pump 41 (first embodiment) and in the case of the fuel filtration device 30 disposed on the downstream side of the feed pump 41 (second embodiment), the invention is applied to the fuel filtration device 30 in both the cases. More specifically, in the case of the suction negative pressure-type filtration device (first embodiment), the valve 33 may be selected based on the pressure (negative pressure) on the downstream side of the valve 33 at the clogging generated time, and in the case of the positive pressure-type filtration device (second embodiment), the valve 33 may be selected based on the pressure (positive pressure) on the upstream side of the valve 33 at the clogging generated time. As a result, the constitution of the fuel filtration device 30 except the valve 33 is made common to both the above types.

Modifications of the above embodiments will be described below. The invention is not limited to the descriptions in the above-described embodiments, and may be embodied through the modifications as follows.

In the above embodiments, the first and second filters 31, 32 are elements that are formed separately from each other. Alternatively, a single element may be used for the first and second filters 31, 32. More specifically, by eliminating the intermediate stay 372 illustrated in FIG. 3 and by dividing the first flow route 30a from the second flow route 30b with the partition plate 363 on a downstream side of a single element, a part of the single element above the partition plate 363 may function as the first filter 31, and a part of the single element below the partition plate 363 may function as the second filter 32. Accordingly, compared with when different elements are employed respectively for the first and second filters 31, 32, the structure of the fuel filtration device 30 is simplified, e.g., the intermediate stay 372 becomes unnecessary. However, in the case where the first and second filters 31, 32 is divided off by the intermediate stay 372 as in the first and second embodiments, a degree of sail of the second filter 32 because of foreign substance in fuel at normal time is reduced.

In the above embodiments, when the first filter 31 is replaced, the first filter 31 is replaced together with the second filter 32. Alternatively, the first and second filters 31, 32 may be made respectively attachable to and detachable from the filter holding member. After the filter holding member is detached from the filter head 34, the first and second filters 31, 32 may be respectively replaced separately. Accordingly, if the clogging of the second filter 32 has not become advanced at the time of replacement of the first filter 31, the second filter 32 continues to be used without replacement.

In the above embodiments, the first and second filters 31, 32 are held by a single filter holding member. Alternatively, the first and second filters 31, 32 may be held respectively by different filter holding members.

In the above embodiments, the switch 333 is provided for the valve 33, and the generation of clogging of the first filter 31 is detected based on whether the valve opening signal has been sent from the switch 333. However, the invention is not limited to such a detection method. For instance, a differential pressure sensor for detecting the differential pressure between before and after the valve 33 may be provided. Based on a detection signal from the differential pressure sensor, the generation of clogging may be detected. Or, the generation of clogging may be detected based on a travel distance of the vehicle.

Additional advantages and modifications will readily occur to those skilled in the art. The invention in its broader terms is therefore not limited to the specific details, representative apparatus, and illustrative examples shown and described.

What is claimed is:

1. A fuel filtration device comprising:
a first filter that is normally used to filter foreign substances contained in fuel;
a second filter that is used to filter the foreign substances contained in the fuel only in a state where a degree of clogging of the first filter is larger than a predetermined level; and
a regulating means for regulating a flow of the fuel through the second filter, wherein:
the regulating means disables the flow of the fuel through the second filter to limit the filtering of the foreign substances through the second filter when the degree of clogging of the first filter is equal to or smaller than the predetermined level; and
the regulating means enables the flow of the fuel through the second filter to permit the filtering of the foreign substances through the second filter when the degree of clogging of the first filter is larger than the predetermined level.

2. The fuel filtration device according to claim 1, wherein:
a flow route is connected to one of an inlet and outlet of the second filter;
the regulating means includes a valve that is driven to open or close the flow route;
the valve closes the flow route when the degree of clogging of the first filter is equal to or smaller than the predetermined level; and
the valve opens the flow route when the degree of clogging of the first filter is larger than the predetermined level.

3. The fuel filtration device according to claim 2, wherein:
the valve is a mechanical valve that is opened to open the flow route when a pressure difference between a pressure applied to the valve on an upstream side of the valve and a pressure applied to the valve on a downstream side of the valve is larger than a predetermined value; and
the valve is arranged in the flow route such that the pressure difference varies depending on a degree of clogging of the first filter.

4. The fuel filtration device according to claim 3, wherein the valve is opened when the pressure applied to the valve on the downstream side of the valve is decreased below a predetermined pressure.

5. The fuel filtration device according to claim 3, wherein the valve is opened when the pressure applied to the valve on the upstream side of the valve is increased above a predetermined pressure.

6. The fuel filtration device according to claim 2, further comprising a sensing means for sensing an open state of the valve, wherein when the valve is held in the open state to open the flow route, the sensing means outputs a signal, which indicates the open state of the valve.

7. The fuel filtration device according to claim 1, further comprising:
a filter head that has a fuel inlet and a fuel outlet, the fuel inlet communicating with inlets of the first and second filters and the fuel outlet communicating with outlets of the first and second filters; and
a filter holding member that holds the first and second filters and is detachably attached to the filter head.

8. The fuel filtration device according to claim 1, wherein a size of the second filter is smaller than that of the first filter to provide a smaller filtering area in comparison to that of the first filter.

9. The fuel filtration device according to claim 1, wherein the first filter and the second filter are placed adjacent to each other.

10. A fuel supply system for an internal combustion engine, comprising:
a fuel tank that receives fuel;
a low pressure fuel pump that pumps the fuel out of the fuel tank;
a high pressure fuel pump that further pressurizes and pumps the fuel, which is supplied from the low pressure fuel pump; and
the fuel filtration device of claim 1 placed in one of:
a fuel conduit that connects between the fuel tank and the low pressure fuel pump; and
a fuel conduit that connects between the low pressure fuel pump and the high pressure fuel pump.
